(19) United States
(12) Patent Application Publication
(10) Pub. No.: US 2025/0345947 A1
(43) Pub. Date: Nov. 13, 2025

(54) Robotic Arm Apparatus

(71) Applicant: Soly Halabi, Brooklyn, NY (US)

(72) Inventor: Soly Halabi, Brooklyn, NY (US)

(21) Appl. No.: 18/659,843

(22) Filed: May 9, 2024

(51) Int. Cl. B25J 11/00; B25J 9/12; B25J 15/00

(52) U.S. Cl. CPC B25J 11/009; B25J 9/126; B25J 15/0019

(57) ABSTRACT

A robotic arm apparatus having an interchangeable sensory attachment. The sensory attachment provides a sensory stimulus to a user. Some of the sensory attachment options available to the user include a feather, a scratching member, and a plurality of tentacles. The robotic arm utilizes multiple arm segments with multiple motors to position the arm in various configurations. Additionally, using a processing unit and a Bluetooth module, a user may program the robotic arm and communicate with the arm wirelessly.

### FIELD OF THE INVENTION

The present invention relates generally to a robotic arm. More specifically, the present invention is a robotic arm having a sensor attachment for providing a user with a sensory stimulus.

### BACKGROUND OF THE INVENTION

In the modern world, stress and discomfort are prevalent issues affecting a large segment of the population, particularly those who are elderly, physically disabled, or those experiencing chronic pain. Many individuals face challenges in performing daily tasks that involve reaching or scratching different parts of their body due to limitations in mobility or flexibility. Moreover, people who live alone or are confined to specific settings, such as hospitals or nursing homes, may not always receive adequate personal care and comfort due to staffing limitations or the absence of a caregiver.

Traditional solutions to these problems have often involved the use of static tools, such as back scratchers or massage rollers, which do not provide adaptable or variable responses to a user's specific needs. These tools require manual operation, which is not always feasible for those with physical limitations. Furthermore, these solutions lack the capability to deliver diverse types of sensory stimuli in a manner that adapts to the changing preferences or needs of the user.

Robotic technology in the field of personal care and comfort is emerging as a viable solution to these challenges. However, existing robotic systems are primarily focused on functional tasks, such as lifting or moving objects, rather than providing personalized sensory stimulation. Such systems typically lack the sophistication to adapt to the nuanced preferences of individual users, and do not offer a variety of sensory experiences that can be tailored to suit personal comfort levels.

The invention described herein seeks to address these gaps by introducing a robotic arm with a sensory attachment that provides a user with a sensory stimulus. This robotic arm is equipped with a base connected to one end of the arm, with the sensory attachment affixed to the opposite end. The sensory attachment can include various elements such as a back scratcher, a feather, or multiple tentacles, each designed to deliver a distinct type of soothing stimulus according to the user's preferences or needs. In some cases, the invention may include a chilling feature whereby air may be blown onto the user from an air pump housed within the invention.

One of the core innovations of this invention is its programmable nature, allowing for the customization of movements and stimuli. This feature enables the robotic arm to adapt to the specific requirements of different users, enhancing their comfort and satisfaction. For instance, the arm can be programmed to vary the pressure, speed, and pattern of movement, thereby catering to the unique preferences of each user, which might change over time or according to the context of use.

Furthermore, the invention leverages advanced sensory feedback systems that enable the robotic arm to respond dynamically to the user's immediate physical reactions or the environment. This responsiveness ensures that the stimuli provided are consistently within the comfort threshold of the user, thereby maximizing relief and satisfaction.

In summary, the robotic arm with a sensory attachment described in this invention represents a significant advancement in the field of personal comfort and caregiving. By integrating programmable capabilities with a variety of attachable sensory tools, this invention provides a flexible, responsive, and user-focused solution to the ongoing challenges of personal comfort and physical accessibility. The introduction of this technology promises to enhance the quality of life for many, particularly those with limited mobility or those in need of regular personal care.

### BRIEF DESCRIPTION OF THE DRAWINGS

FIG. 1 is a profile view of the present invention.

FIG. 2 is an exploded view of the present invention. FIG. 3 is a profile sectional view of the present invention.

FIG. 4 is a section view of the base member of the present invention.

FIG. 5 is a circuit diagram of the present invention.

FIG. 6 is a perspective view of the present invention.

FIG. 7 is a chart of the sensory attachments of the present invention.

FIG. 8 is a section view of the present invention showing the

FIG. 9 is a diagram of the Bluetooth module and remote of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of a robotic arm apparatus having a sensory attachment, embodiments of the present disclosure are not limited to use only in this context.

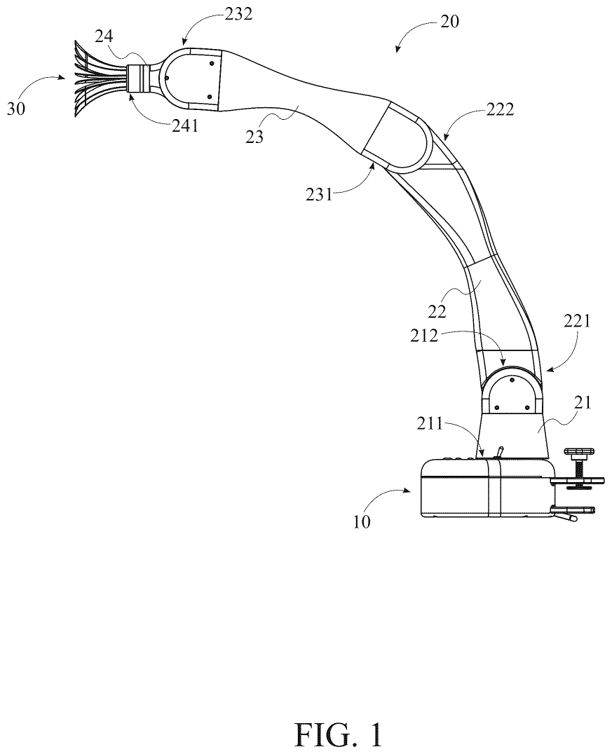

As shown in FIG. 1 the present invention is a robotic arm apparatus having a sensory attachment comprising a base member 10, an arm 20, and a sensory attachment 30. In the preferred embodiment of the present invention, the arm 20 is rotatably attached to the base member 10. Moreover, the sensory attachment 30 is coupled to the arm 20 at an end opposite from the base member 10. In the context of the present invention, the sensory attachment 30 is an apparatus coupled to the arm 20 that, when moved in a rotational movement, a lateral movement, a linear movement, an oscillating movement, a reciprocating movement, or a movement of the like, may provide a sensory stimulus to a user. In some embodiments of the present invention, the sensory attachment 30 is selected from one of the apparatuses including a feather 32, a member comprising a plurality of tentacles 33, a scratching apparatus 34, and apparatuses of the like 35.

As further shown in FIG. 1, the arm 20 of the present invention is composed of a first arm member 22, a second arm member 23, a third arm member 24, and a rotary base member 21. In the preferred embodiment of the present invention, the rotary base member 21 is rotatably coupled to the first arm member 22; the first arm member 22 is further rotatably coupled to the second arm member 23; and the second arm member 23 is rotatably coupled to the third arm member 24. Furthermore, within the preferred embodiment of the present invention, the rotary base member 21 is rotatably coupled to the base member 10. Additionally, within the preferred embodiment of the present invention, the third arm member 24 is rotatably coupled to the sensory attachment 30.

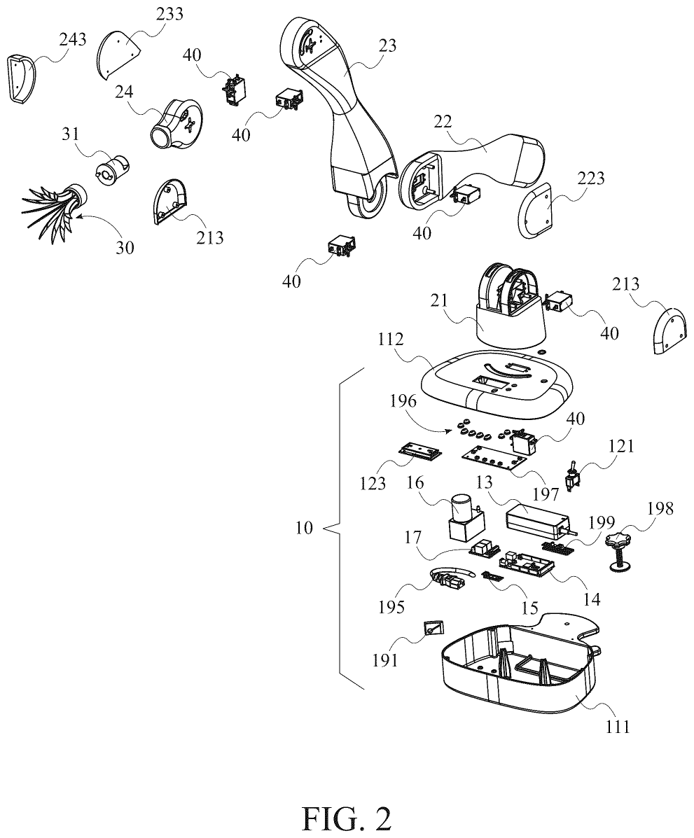

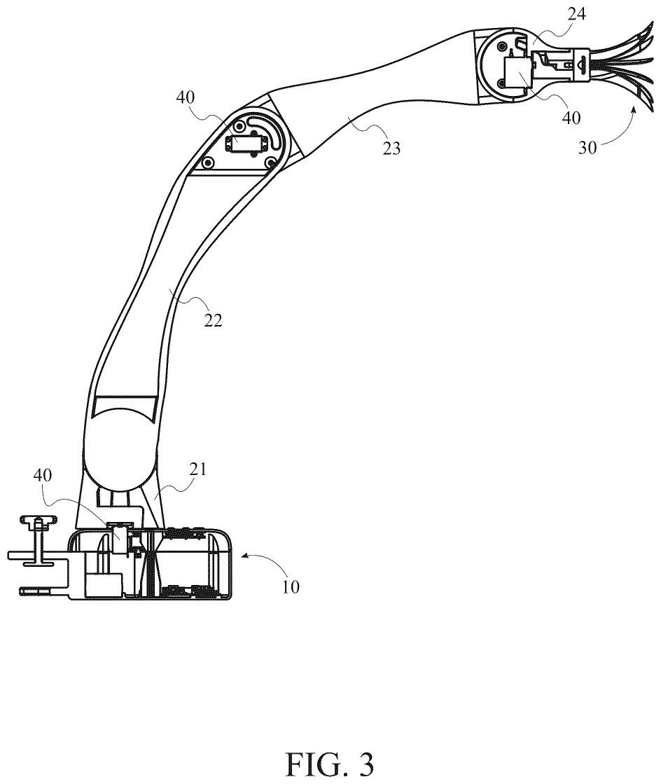

In the preferred embodiment of the present invention, as shown in FIG. 2 and FIG. 3, the base member 10 is coupled to the rotary base member 21, wherein a motor 40 facilitates rotary motion of the rotary base member 21, relative to the base member 10. Furthermore, the first arm member 22 is coupled to the rotary base member 21, via a joint wherein the joint comprises a motor 40. In the context of the present invention, a motor 40 is a device, known to those in the art, that facilitates rotary movement. Furthermore, within the context of the present invention, a joint is the interface location between adjacent arm members. Additionally, the second arm member 23 is coupled to the first arm member 22, via a joint, wherein said joint comprises a motor 40. Lastly, the third arm member 24 is coupled to the second arm member 23, via a joint, wherein said joint also comprises a motor 40. Moreover, the sensory attachment 30 is coupled to the third arm member 24 wherein a motor 40 facilitates rotary motion of the sensory attachment 30 relative to the third arm member 24. In some embodiments of the present invention, a joint 31 is interposed between the sensory attachment 30 and the third arm member 24, further facilitating motion.

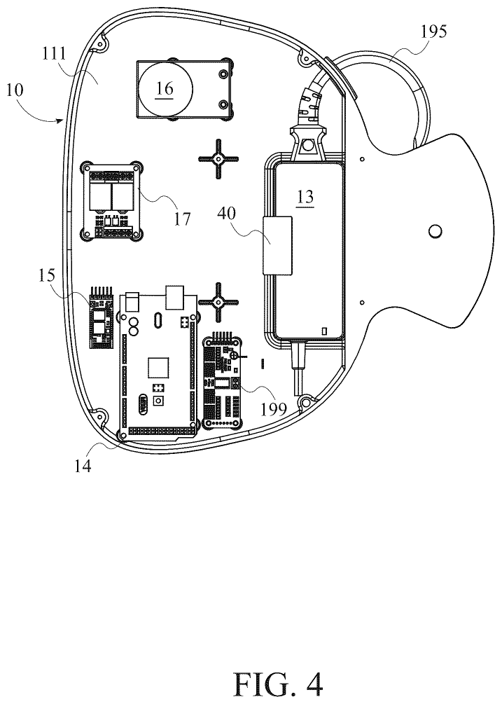

In the preferred embodiment of the present invention as shown in FIG. 2, the base member 10 of the present invention is a housing wherein said housing contains components of the robotic arm apparatus that facilitate user interaction including those components critical to the operation of the present invention. In the preferred embodiment, as shown in FIG. 2 and FIG. 4, the base member 10 comprises a processing unit 14, a user interface 12, a power supply 13, a Bluetooth module 15, an air pump 16, a relay 17, and a plurality of hardware. The processing unit 14, in the context of the present invention is a computing device capable of executing a computer-readable methods and processes, as understood by those of ordinary skill in the art. In the context of the present invention, the user interface 12 comprises a toggle switch 121, a plurality of buttons 122, and an LCD screen 123. The toggle switch 121 of the present invention, within the preferred embodiment, is a power control device, turning the robotic arm apparatus on and off. In the preferred embodiment of the present invention, the plurality of hardware are components of the robotic arm apparatus that communicate information, signals, and power between components and provide structural support to components wherein such hardware comprises a power cord 195, a data cable 192, a plurality of jumper wires (not shown), a plurality of button covers 196, a button plate 197, a fixation knob 198, a cord support 191, and a motor driver 199.

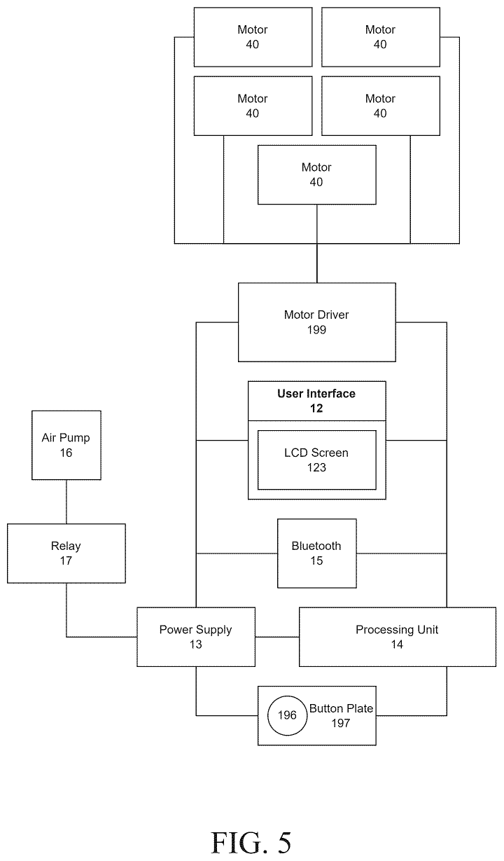

As shown in FIG. 5, the processing unit 14 communicates signals between said processing unit 14 and each of the motor driver 199, the user interface 12, the Bluetooth module 15, and the button plate 197. Likewise, the power supply 13 provides power to each of the following including: the air pump 16, the relay 17, the motors 40, the motor driver 199, the user interface 12, and the button plate 197. Within the context of the present invention, each motor 40 communicates with the motor driver 199 wherein said motor driver 199 communicates and receives power from the processing unit 14 and the power supply 13, respectively.

In the preferred embodiment of the present invention, the base member 10 is composed of a bottom member 111 and a top member 112. In the context of the present invention, the bottom member 111 is a vessel-like structure wherein the top member 112 is a lid-like structure. In the preferred embodiment of the present invention, the bottom member 111 holds the components contained within the base member 10, as shown in FIG. 4, wherein the top member 112 covers such components and provides a mounting surface for the rotary base member 21.

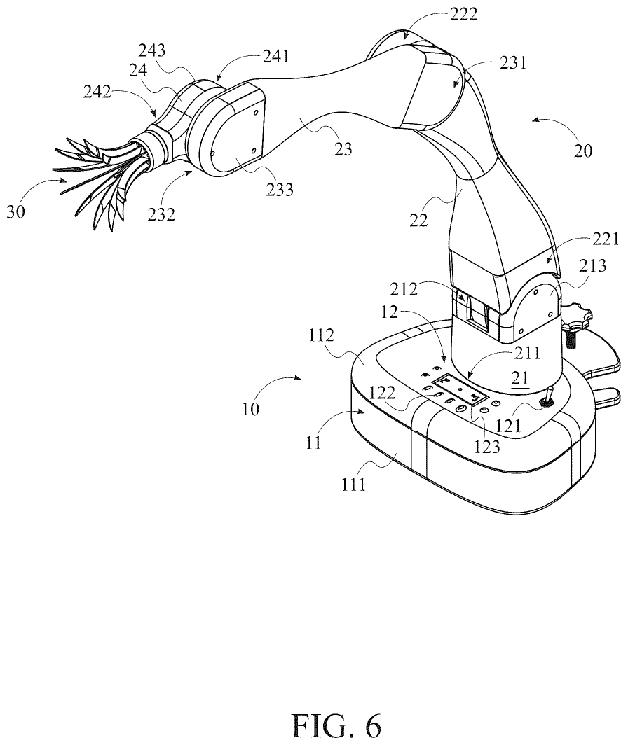

As shown in FIG. 6, the rotary base member 21 of the present invention comprises a base member interface 211, a first arm interface 212, and an at least one cover 213. In the context of the present invention, the base member interface 211 is the portion of the rotary base member 21 contacting the base member 10. Moreover, within the context of the present invention, the first arm interface 212 is the portion of the rotary base member 21 contacting the first arm 22. Furthermore, as shown in FIG. 6, and within the context of the present invention, the at least one cover 213 is a panel concealing the motor 40 and joint between the two adjacent arm members.

As shown in FIG. 6, the first arm 22 is an elongated member comprising a first end 221 and a second end 222 wherein the first end 221 is adjacent to the rotary base member 21 and the second end 222 is adjacent to the second arm member 23. Furthermore, the first arm member 22 further comprises an at least one cover 223, wherein similar to the at least one cover 213 of the rotary base member 21, the at least one cover 223 of the first arm member 22 is a panel located at the joints shared by the first arm member 22, concealing the motors 40 at each respective joint.

Similarly to the first arm member 22, the second arm member 23, as shown in FIG. 6, comprises a first end 231 and a second end 232 wherein the first end 231 is adjacent to the second end 222 of the first arm member 22 and the second end 232 is adjacent to the third arm member 24. The second arm member 23 further comprises an at least one cover 233 wherein said cover 233 is a panel that conceals the motor 40 located within each joint shared by the second arm member 23.

As shown in FIG. 6, the third arm member 24 comprises a second arm interface 241 and a sensory attachment interface 242. In the context of the present invention, the second arm interface 241 is the portion of the third arm member 24 that contacts the second arm member 23 and the sensory attachment interface 242 is the portion of the third arm member 24 contacting the sensory attachment 30. Additionally, within the preferred embodiment of the present invention, the third arm member 24 comprises an at least one cover 243 wherein said cover 243 is a panel located at the joint shared by the third arm, concealing the motor 40.

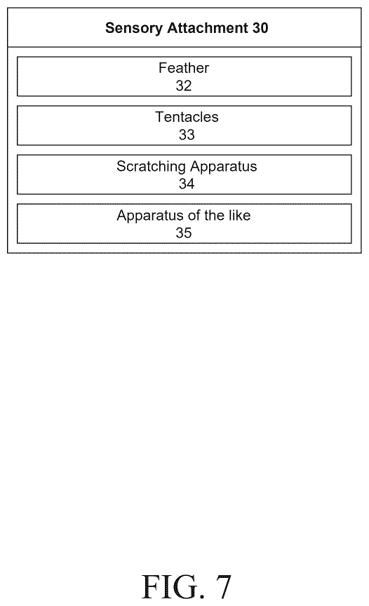

In the preferred embodiment of the present invention, the sensory apparatus 30 extends from the sensory attachment interface 242 of the third arm member 24, outwardly. In the preferred embodiment of the present invention, the sensory attachment 30 provides a sensory stimulus to a user upon the motion of the arm. Furthermore, as previously stated, the sensory attachment is selected from one of the apparatuses including a feather 32, a member comprising a plurality of tentacles 33, a scratching apparatus 34, and apparatuses of the like 35, as shown in FIG. 7.

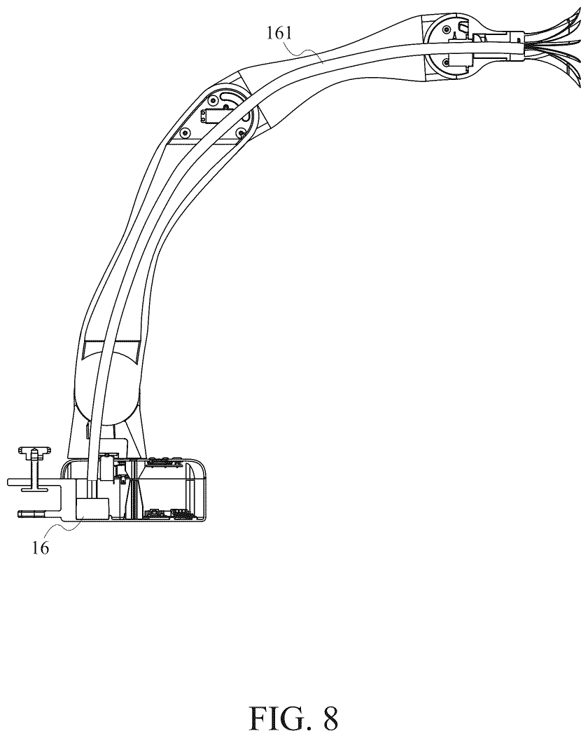

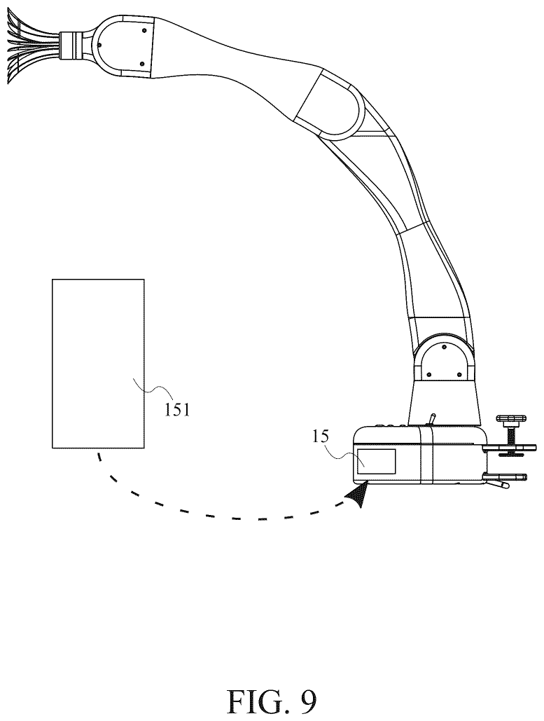

Additionally, as shown in FIG. 8, in some embodiments, the present invention further comprises a channel 161, traversing the arm 20 to provide a means for communicating air to the user. In such embodiments, the channel 161 communicates air from the air pump 16, through the arm 20. The movement of air through the channel 161 is an additional sensory stimulus provided to the user. Furthermore, as shown in FIG. 9, in some embodiments of the present invention, the user may utilize a remote 151 to communicate with the Bluetooth module 15 of the present invention, thus controlling the movement and functionality of the present invention. In the context of the present invention, the remote 151 is a wireless transmitter capable of communicating with the Bluetooth module 15. In the context of the present invention, the remote 151 may comprise a phone, a tablet, a remote controller, and devices of the like.

Although the invention has been explained in relation to its preferred embodiment, it is to be understood that many other possible modifications and variations can be made without departing from the spirit and scope of the invention.

What is claimed is:

1. A robotic arm apparatus comprising:
an arm; and
a sensory attachment;
wherein:
the arm comprises a rotary base member;
said rotary base member comprising a motor, thus facilitating rotation of the arm;
the sensory attachment coupled to the arm, thus providing a sensory stimulus to a user upon movement of the arm.

2. The robotic arm apparatus as claimed in claim 1, wherein the arm further comprises:
a plurality of arm members; and
a plurality of joints;
wherein
each arm member of the plurality of arm members is rotatably coupled to at least one adjacent arm member;
each coupling being a joint comprising a motor; and
said motor facilitating rotation between adjacent arm members.

3. The robotic arm apparatus as claimed in claim 2, wherein the plurality of arm members comprises:
a first arm member;
a second arm member; and
a third arm member;
wherein:
each arm member comprises a first end and a second end;
the first end of the first arm member being rotatably coupled to the rotary base member;
the second end of the first arm member being rotatably coupled to the first end of the second arm member;
the second end of the second arm member being rotatably coupled to the first end of the third arm member; and
and the second end of the third arm member being rotatably coupled to the sensory attachment.

4. The robotic arm apparatus as claimed in claim 3 wherein the sensory attachment comprises a plurality of tentacles.

5. The robotic arm apparatus as claimed in claim 3 wherein the sensory attachment comprises a feather.

6. The robotic arm apparatus as claimed in claim 3 wherein the sensory attachment comprises a scratching apparatus.

7. The robotic arm apparatus as claimed in claim 3, further comprising a base member wherein the rotary base member is rotatably coupled to the base member.

8. The robotic arm apparatus as claimed in claim 7 wherein the base member is a housing;
the base member containing a processing unit wherein said processing unit executes computer-readable methods and communicates data to the motors, facilitating rotation the each of the arm members.

9. The robotic arm apparatus as claimed in claim 8 wherein the base member further comprises:
a user interface comprising at least one of:
a toggle switch;
an at least one button; and
an LCD screen.

10. The robotic arm apparatus as claimed in claim 9 wherein the base member further comprises a power supply.

11. The robotic arm apparatus as claimed in claim 10 wherein the motor of the rotary base member is housed within the base member.

12. A robotic arm apparatus comprising:
a base member;
an arm; and
a sensory attachment;
wherein:
the arm is rotatably coupled to the base member;
the sensory attachment is rotatably coupled to the arm, opposite the base member;
the sensory attachment providing a sensory stimulus to a user upon movement of the sensory attachment.

13. The robotic arm apparatus as claimed in claim 12 wherein the arm comprises:
a plurality of arm members comprising:
a rotary base member;
a first arm member;
a second arm member; and
a third arm member;
a plurality of motors; and
a plurality of joints;
wherein:
each of the plurality of arm members comprising a first end and a second end;
the first end of the rotary base member being rotatably coupled to the base member wherein said coupling is a joint comprising a motor;
the second end of the rotary base member being rotatably coupled to the first end of the first arm member wherein said coupling is a joint comprising a motor;
the second end of the first arm member being rotatably coupled to the first end of the second arm member wherein said coupling is a joint comprising a motor;
the second end of the second arm member being rotatably coupled to the first end of the third arm member wherein said coupling is a joint comprising a motor; and
the second end of the third arm member being rotatably coupled to the sensory attachment wherein said coupling is a joint comprising a motor.

14. The robotic apparatus as claimed in claim 13 wherein the sensory attachment is selected from:
a sensory attachment comprising a plurality of tentacles;
a feather; and
a scratching apparatus.

15. The robotic arm apparatus as claimed in claim 14 wherein the base member comprises:
a processing unit wherein said processing unit executes computer-readable methods and communicates data to the motors, facilitating rotation the each of the arm members; and
a user interface comprising at least one of:
a toggle switch;
an at least one button; and
an LCD screen.

16. The robotic arm apparatus as claimed in claim 15 wherein the base member further comprises a power supply.

17. A robotic arm apparatus comprising:
an arm;
a base member; and
a sensory attachment;
wherein:
the arm is interposed between the base and the sensory attachment;
the arm comprises a rotary base member wherein said rotary base member is rotatably coupled to the base member;
said rotary base member comprising a motor, wherein said motor is housed within the base member, thus facilitating rotation of the arm;
the sensory attachment coupled to the arm, thus providing a sensory stimulus to a user upon movement of the sensory attachment;
the sensory attachment being interchangeably selected from:
a plurality of tentacles;
a feather; and
a scratching apparatus;
the base member further housing a Bluetooth module wherein a user may wirelessly communicate with the robotic arm apparatus.

18. The robotic arm apparatus as claimed in claim 17 wherein the base member comprises:
a processing unit wherein said processing unit executes computer-readable methods and communicates data to the motors, facilitating rotation the each of the arm members;
a power supply; and
a user interface comprising at least one of:
a toggle switch;
an at least one button; and
an LCD screen.

19. The robotic arm apparatus as claimed in claim 17, wherein the arm further comprises:
a plurality of arm members; and
a plurality of joints;
wherein
each arm member of the plurality of arm members is rotatably coupled to at least one adjacent arm member;
each coupling being a joint comprising a motor; and
said motor providing a means of rotation between adjacent arm members.

20. The robotic arm apparatus as claimed in claim 19, wherein the sensory attachment is coupled to a motor, wherein said motor is housed within the arm.
